(19) United States
(12) Patent Application Publication
(10) Pub. No.: US 2009/0015535 A1
(43) Pub. Date: Jan. 15, 2009

(54) DRIVING CIRCUIT FOR A LIQUID CRYSTAL DISPLAY

(75) Inventors: Hong Seok Jeong, Chungcheongbuk-do (KR); Dae Seong Kim, Daejeon-si (KR); Dae Keun Han, Daejeon-si (KR)

Correspondence Address: CANTOR COLBURN, LLP, 20 Church Street, 22nd Floor, Hartford, CT, 06103, US

(73) Assignee: SILICON WORKS CO., LTD., Daejeon-si (KR)

(21) Appl. No.: 12/097,006

(22) PCT Filed: Dec. 7, 2006
(86) PCT No.: PCT/KR06/05263

§ 371 Date: Jun. 11, 2008

(30) Foreign Application Priority Data
Jan. 21, 2006 (KR) 10-2006-0006578

(51) Int. Cl. G09G 3/36

(52) U.S. Cl. 345/98

(57) ABSTRACT

Provided is a driving circuit for a liquid crystal display which is suitable for reducing a chip size and has improved noise immunity in a circuit which uses a level shifter and is constructed with a channel array. The driving circuit includes: the level shifter which is disposed in a previous stage of a channel region and shifts up a level of a data signal output from a buffer to output the data signal to the channel region; and the channel region which processes an output data of the level shifter in a format requested by a system and outputs a final data in a high or low format, and wherein the level shifter is disposed in a region excluding the channel region.

### TECHNICAL FIELD

The present invention relates to a design technology for a driving circuit for a liquid crystal display, and more particularly, to a driving circuit for a liquid crystal display which is suitable for reducing a chip size and has improved noise immunity in a circuit which uses a level shifter and is constructed with a channel array.

### BACKGROUND ART

In general, a liquid crystal display (LCD) is a flat panel display apparatus for displaying characters, symbols, or graphics. In addition, the LCD is a display apparatus which uses optical characteristics of the liquid crystal molecules of which arrangement is changed by an electric field. The LCD is constructed by using a liquid crystal technology and a semiconductor technology.

FIG. 1 is a conventional driving circuit for LCD. As shown in FIG. 1, the conventional driving circuit includes: a buffer 11 for temporarily storing an input data; a shift register 12 for outputting an output data of the buffer 11 in a format according to a specification requested by a system; a level shifter 13 for shifting up a level of a digital video signal output from the shift register 12 and outputting a high-voltage signal; an output controller 14 for receiving an output data from the level shifter 13 to output a data having a format requested by the system; and an output driver 15 for receiving the output data from the output controller 14 to output a final data in a high or low format. Now, operations of the conventional driving circuit for the LCD are described in detail.

The buffer 11 stores the input data temporarily. The shift register 12 in a channel region 10 outputs the output data of the buffer 11 in a format according to the specification requested by the system. The channel denotes one of the same array structures.

The buffer 11 and the shift register 12 disposed in a control logic stage use the same voltage VCC-GND (for example, VCC-GND: from 2.4 to 3.6V).

On the other hand, the output controller 14 and the output driver 15 disposed in the next LCD output driver stage use a voltage VGH-VGL (for example, VGH-VGL: from 15 to 40V) which is different from the voltage VCC-GND.

Therefore, since the level shifter 13 is disposed between the shift register 12 and the output controller 14, it is possible to change a level of the digital video signal output from the shift register 12 from a low-voltage level VCC-GND to a high-voltage level VGH-VGL to output to the output controller 14.

The output controller 14 receives the output data from the level shifter 13 to output the data in the format requested by the system. In addition, the output driver 15 receives the output data from the output controller 14 outputs the final data in the high or low format.

As described above, since a conventional driving circuit for a liquid crystal display (LCD) has a level shifter in a channel region for removing a difference of power-supply levels between a control logic stage and an LCD output driver stage, there are shortcomings that a chip size is increased, and noise immunity is weak.

### DISCLOSURE OF INVENTION

### Technical Problem

The present invention provides a driving circuit for a liquid crystal display (LCD) capable of removing a difference of power-supply levels between a control logic stage and an LCD output driver stage by changing a position in which a level shifter is disposed.

### Technical Solution

According to an aspect of the present invention, there is provided a driving circuit for a liquid crystal display, comprising: a level shifter which is disposed in a previous stage of a channel region and shifts up a level of a data signal output from a buffer to output the data signal to the channel region; and the channel region which processes an output data of the level shifter in a format requested by a system and outputs a final data in a high or low format, wherein the level shifter is disposed in a region excluding the channel region.

### BRIEF DESCRIPTION OF THE DRAWINGS

FIG. 1 is a block diagram showing a conventional driving circuit for a liquid crystal display.

FIG. 2 is a block diagram showing a driving circuit for a liquid crystal display according to the present invention.

FIGS. 3 and 4 are views for comparing a layout of a power-supply level used by a channel region according to the present invention with a conventional layout.

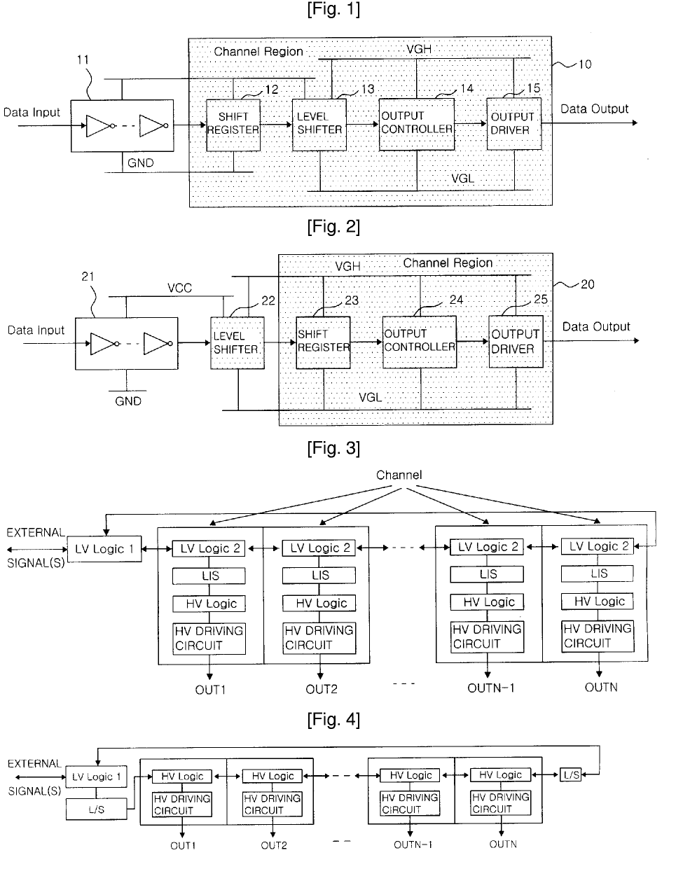

### BEST MODE FOR CARRYING OUT THE INVENTION

Hereinafter, an exemplary embodiment of the present invention will be described in detail with reference to the attached drawings.

FIG. 2 is a block diagram showing a driving circuit of a liquid crystal display (LCD) according to an embodiment of the present invention. As shown in FIG. 2, the driving circuit includes: a buffer 21 for temporarily storing an input data; a level shifter 22 for shifting up a level of a data signal output from the buffer 21 to output a high-voltage signal; a shift register 23 for outputting an output data of the level shifter 22 in a format according to a specification requested by a system; an output controller 24 for receiving the output data of the shift register 23 to output the data in the format requested by the system; and an output driver 25 for receiving the output data from the output controller 24 to output a final data in a high or low format. Hereinafter, operations of the driving circuit shown in FIG. 2 are described in detail with reference to FIG. 3.

The buffer 21 stores an input data temporarily. The level shifter 22 changes a level of a digital video signal output from the buffer 21 from a low-voltage level VCC-GND (from 2.4 to 3.6V) to a high-voltage level VGH-VGL (from 15 to 40V) to output to the shift register 23.

As shown in FIG. 2, it should be noted that the level shifter 22 is disposed not in the channel region 20 but in a previous stage of the channel region 20. As described above, a level of the digital video signal is changed from the low-voltage level VCC-GND to the high-voltage level VGH-VGL by the level shifter 22 in the previous stage of the channel region 20. The resulting digital video signal is transmitted to an LCD output driver stage in the channel region 20.

In addition, since the channel region 20 does not have the level shifter 22 occupying a relatively large area, it is possible to facilitate an integration of the channel region 20. In addition, since the shift register 23 storing data uses the high-voltage level VGH-VGL, it is possible to improve noise immunity compared with a conventional driving circuit using the low-voltage level VCC-GND.

The shift register 23 in the channel region 20 outputs the digital video signal changed into the high-voltage signal by the level shifter 22 in a format according to the specification requested by the system. The channel denotes one of the same array structures.

In addition, the output controller 24 outputs the output data of the shift register 23 in the format requested by the system. The output driver 25 receives the output data from the output controller 24 to output the final data in the high or low format.

FIGS. 3 and 4 are views for comparing a layout of a power-supply level used by a channel region according to the present invention with a conventional layout.

As shown in FIG. 3, since the conventional channel region has the level shifter, the level shifter uses both VCC-GND and VGH-VGL in the channel region. However, as shown in FIG. 4, the channel region according to the present invention does not have the level shifter. Since the level shifter is not used by the channel region, it is possible to reduce a layout area.

### INDUSTRIAL APPLICABILITY

As described above, according to the present invention, a level shifter is disposed in a previous stage of a channel region, and a shift register is disposed in the channel region. Accordingly, it is possible to improve an integration of the channel region and noise immunity.

1. A driving circuit for a liquid crystal display which includes a channel region array of the same structure circuit having two or more operating voltage ranges, comprising:
a level shifter which shifts up a level of a data signal output from a buffer to output the data signal to the channel region; and
the channel region which processes an output data of the level shifter in a format requested by a system and outputs a final data in a high or low format, and
wherein the level shifter is disposed in a region excluding the channel region.

2. The driving circuit for a liquid crystal display of claim 1, wherein the level shifter shifts up the level of the data signal from a low-voltage level VCC-GND to a high-voltage level VGH-VGL to output the data signal to the channel region.

3. The driving circuit for a liquid crystal display of claim 2, wherein the low-voltage level VCC-GND is in a range of about 2.4 to 3.6V.

4. The driving circuit for a liquid crystal display of claim 2, wherein the high-voltage level VGH-VGL is in a range of about 15 to 40V.

5. The driving circuit for a liquid crystal display of claim 1, wherein the channel region further comprises:
a shift register for outputting the output data of the level shifter in a format according to a specification requested by a system;
an output controller for outputting the output data of the shift register in the format requested by the system; and
an output driver for outputting the output data of the output controller according to a final data in a high or low format.

6. The driving circuit for a liquid crystal display of claim 1, wherein the channel region has an LCD output driver stage.
